(19) United States
(12) Patent Application Publication
(10) Pub. No.: US 2026/0339873 A1
(43) Pub. Date: Oct. 29, 2026

(54) METHOD FOR THE TRANSMISSION OF DATA, AND BUS NODE

(71) Applicant: Continental Automotive Technologies GmbH, Hannover (DE)

(72) Inventors: Thorsten Fahlbusch, Frankfurt (DE); Tobias Beckmann, Eschborn (DE)

(73) Assignee: Continental Automotive Technologies GmbH, Hannover (DE)

(21) Appl. No.: 19/107,139

(22) PCT Filed: Aug. 9, 2023
(86) PCT No.: PCT/DE2023/200159

§ 371 Date: Feb. 27, 2025

(30) Foreign Application Priority Data
Aug. 29, 2022 (DE) 10 2022 208 902.2

(51) Int. Cl. G06F 13/42

(52) U.S. Cl. CPC G06F 13/42

(57) ABSTRACT

A method for transmitting data via a bus line, is disclosed wherein the data to be transmitted are received and inserted into respective data fields of at least first frames and second frames, and the first frames are transmitted simultaneously with the second frames. The embodiments further relate to an associated bus node of a bus system.

### TECHNICAL FIELD

A method for transmitting data via a bus line and to an associated bus node is described.

### BACKGROUND

The amount of data exchanged between components of a motor vehicle has increased considerably in recent years and will markedly increase even further in the future. Reasons for this are, for example, the increase in road safety, the reduction in fuel or electricity consumption, the increasing functionality for implementing autonomous or partly autonomous driving and the growing need for entertainment functions in the vehicle. Document DE 10 2012 224 024 A1, for instance, describes a method for exchanging data between participants connected to one another by means of a bus system, wherein the data contain a sequence of bits. In this case, a control bit is provided to enable error monitoring.

For a long time, recourse has been made to CAN bus systems in order to exchange data between components of a motor vehicle. There are various standards for this. In this case, in order to increase the data rates, the bit times have often been reduced or the number of data bits per frame has been increased. However, it has been found that known CAN bus systems are scalable and flexible only to a certain extent and, in the event of a further increase in the required data rates, they no longer offer sufficient performance.

### SUMMARY

It is therefore an object to provide a method for transmitting data via a bus line and to provide an associated bus node.

A method for transmitting data via a bus line, wherein the method comprises the following steps:
reception of the data to be transmitted,
insertion of the data into respective data fields of at least first frames and second frames, and
simultaneous transmission of in each case one first frame with one second frame.

A method of this type can be used to increase the data transfer rate via a bus line compared to known embodiments by virtue of at least two frames being able to be transmitted simultaneously.

According to one embodiment, a sequence of at least three different voltage levels is used in the transmission of the data fields. This enables a particularly high data transfer rate to be achieved. For this purpose, recourse is made not only to two different voltage levels for data transfer, but rather to at least three different voltage levels. This allows the data transfer rate to be increased without physical changes to the bus line being needed.

By way of example, three, four, five or more different voltage levels can be used. Using more than three different voltage levels can increase the data transfer rate even further.

As an alternative to using at least three different voltage levels, for example, the number of lines can also be increased beyond one (for example by using two or more twisted-pair lines), or other methods from telecommunication or wireless communication may be used.

A frame may be understood as meaning for example a number of bits or other data fields that are typically combined to form such a frame as a unit.

According to one embodiment, each frame has a checksum field into which calculated checksums of the data obtained in the respective data field are inserted. Such checksums can be used to increase the reliability of the data transfer. A frame may thus contain at least the data, the checksum field, the header bit and optionally further information. At least the data, the checksum field and/or the header bit can accordingly be transmitted serially within one frame. For example, a superimposed signal is thus not produced and transmitted either, for example, by virtue of a security code being modulated onto the data.

The total length of the checksum fields of a first frame and a simultaneously transmitted second frame may be for example shorter than twice the length of a checksum field of a frame in the case of the data field with the same length. This utilizes the fact that a greater amount of data can be transferred in parallel in the procedure described herein since at least three different voltage levels are used.

The data fields and/or checksum fields of the frames may be for example of the same length. This permits simple execution. That is to say, for example, all frames may have data fields of the same length and/or all frames may have checksum fields of the same length. In other words, the data field and/or the checksum field in a frame 1 may have the same length as the data field and/or the checksum field in a frame 2 or, in the case of three frames, as in frame 3 as well, etc.

In one variant, the bits of the checksum field that have been made available by way of the procedure described herein can be used as additional data bits. As a result, the checksum field can also be used for additional data transfer without this adversely affecting the reliability.

The fields for the bus synchronization, for example header fields (for example SOF, Arbitration, Control Field) and trailer fields (for example ACK Field, EOF, IFS) may be for example of the same length in both frames. This permits simple execution of the method, for example when two or more frames are transferred simultaneously.

As a variant, the fields for the bus synchronization (header fields and trailer fields) in the second (and, if applicable, 3rd, 4th, 5th, etc.) frame can be redefined and used for any purpose. This can increase the flexibility even further.

According to one embodiment, the first frames are CAN frames for CAN bus systems with only two different voltage levels. They may also be backward-compatible with such CAN frames. This results in backward compatibility. This allows simple integration into existing systems.

More generally, the backward compatibility with other systems can also be provided as CAN. In another embodiment, it is possible to arrange for use of conventional CAN communication and the new multilevel CAN communication in mixed operation without the conventional nodes detecting erroneous frames.

According to one embodiment, each frame comprises header fields upstream of the data field and/or checksum field. According to one embodiment, each frame comprises trailer fields downstream of the data field and/or checksum field. Additional information can be transferred as a result.

According to one embodiment, provision is made for bits of the data field of a first frame and of the data field of a simultaneously transmitted second frame to be transmitted simultaneously by the at least three different voltage levels. This allows utilization of the available hardware, for example the bus line.

For example, two frames can be transferred simultaneously. For example, the data field and/or the checksum field of two simultaneously transferred frames can be transferred simultaneously. This permits simple execution.

According to one embodiment, provision is made for arbitration data and/or control data to be transmitted in addition to the data field and/or checksum field only in the first frame, wherein data can be transmitted and/or received simultaneously both in the first frame and in the second frame. As a result, additional payload or capacity for data can be provided in the second frame. For example, only payload data, or only payload data and checksums, can be transmitted in the second frame.

Arbitration and/or control data can be understood as meaning for example data that are not used for transferring payload data and, possibly, directly associated data such as checksums, but instead are used to control the operation of a bus system or another system used for data transfer. For example, they may be used for temporal synchronization.

According to one embodiment, provision is made for arbitration data and/or control data to be transmitted in addition to the data field and/or checksum field both in the first frame and in the second frame. This enables such data to be jointly transmitted in the frame.

According to one development, provision may be made for the data to also be inserted into respective data fields of a third frame, or a third frame and one or more additional frames. This can be understood as a generalization of the principle for two frames. In each case one first frame can be transmitted simultaneously with a second frame and a third frame, or in each case one first frame can be transmitted simultaneously with a second frame, a third frame and one or more additional frames. This enables further parallelization and increasing of the data transfer capacity. In one variant, third and higher frames may be designed like a second frame. Further use of arbitration and control fields of the second, third, etc. frames for other arbitrary purposes is possible, with reference being made in particular to the description given in this respect further above.

For example, a sequence of four or more different voltage levels can be used in the transmission of the data fields and/or in the transmission of the checksum fields. This can increase the capacity further, for example compared to the embodiment using only three voltage levels.

As an alternative, for example, recourse can be made to the aforementioned concepts for using multiple lines or the vectoring.

The bus line for the method denoted above can be for example a CAN bus line, which makes it possible to implement the method in existing systems. It may be in the form of a twisted-pair bus line. Another type of bus line may also be used. The concept described herein is in particular not limited to the use of two bus lines and may be applied to buses with an arbitrarily large amount of electrical or otherwise physical signal transfer methods.

The embodiments further relate to a bus node of a bus system. Said bus node may, but not necessarily, comprise a bus controller and for example a bus interface. The bus interface may be designed for example to transmit data using at least two, three or at least four different voltage levels. The bus node may be configured for example to execute a method as described herein. In this case, recourse can be made to all embodiments and variants described herein. An arbitrarily large number of different voltage levels may be used in principle.

A bus node of this type may be used to implement the method described herein. The bus node may for example receive data and implement same in frames. Said bus node may also receive already processed frames. The bus node may comprise for example processor means and storage means, wherein the storage means store program code, upon the execution of which the processor means execute the method.

An additional embodiment is described below. This may be used together with the concept for data fields that has already been described. However, it can also be realized independently thereof.

The embodiment relates to a method for transmitting data via a bus line.

The method comprises the following steps:
impressing at least one bias volage as voltage onto the bus line,
converting the data into a sequence of at least three different voltage levels, and
modulating the voltage levels onto the bias voltage.

By means of the method just described, the data transfer capacity of a bus line is utilized for transmitting data. Known methods are typically based on the fact that only two different voltage levels are used. In contrast, in the method described herein, at least three different voltage levels are used. This enables simultaneous transfer of higher amounts of data without modifications to the bus line used being required for this.

The voltage levels may be understood for example as a differential voltage. For example, they indicate the difference between the respective current voltage and the bias voltage.

A bus line can be understood as meaning for example a line that can transfer the voltage levels to other components. The bus line may have for example a first conductor and a second conductor which may be electrically insulated from one another. The bias voltage may be a defined voltage which establishes a defined state on the bus line. The voltage levels for data transfer are superposed on said bus line or they are modulated onto same. This may mean for example that the voltage specified by the bias voltage is increased or decreased by the modulation.

A voltage is understood as meaning for example a difference between two potentials. In the present case here, for example a difference between a potential of a conductor or another element of the bus line on the one hand and a potential of another conductor or another element of the bus line or possibly ground on the other hand may be understood. The voltage levels can also be understood as a value by which the bias voltage is changed. The voltage levels may have for example different magnitudes and/or signs.

Conversion is understood for example as meaning that incoming data determine which different voltage levels are produced in succession. Different data produce different voltage levels. This applies for example when considering sufficiently large blocks of multiple voltage levels to be transmitted consecutively. Conversion is considered as the preliminary stage to modulation, that is to say voltage levels produced or stipulated in the modulation are used in the modulation.

The modulation may produce for example a difference between a voltage on the first conductor and a voltage on the second conductor. This enables data transfer.

For example, the same bias voltage as the voltage may be impressed onto the first conductor and the second conductor. This enables a simple embodiment. However, different bias voltages may also be used in principle.

The modulation onto the first conductor may for example be identical in terms of magnitude to the modulation onto the second conductor. As a result, a voltage difference between the two conductors can be increased uniformly distributed across both conductors.

The modulation onto the second conductor may be carried out for example with the reverse sign to modulation onto the first conductor. This permits an increase in the voltage difference on both sides, which is easier to evaluate.

For example, it is thus possible to increase the voltage by 1 V on a first conductor and to decrease the voltage by 1 V on a second conductor. This produces a voltage difference of 2 V.

In principle, however, it is also possible to use different voltage magnitudes for the conductors. For example, the voltage on a first conductor may be increased by 1 V and be decreased by 2 V on a second conductor. This produces a voltage difference of 3 V.

According to another embodiment, the data may be converted into at least four voltage levels. They may also be converted into more than four voltage levels. For example, they may also be converted into five, six, seven or more voltage levels. In principle, an arbitrary number of different voltage levels can be used, with more data being able to be transferred simultaneously the more different voltage levels are used. The effects of an increase in the data transfer capacity are already achieved in principle using three voltage levels. An even further increase in the data transfer capacity is possible using even more voltage levels.

In particular, the bus line may be a CAN bus line. The bus line may be in the form of a twisted-pair bus line. However, other embodiments are also possible here, for example optical variants for data transfer (dark/light) or else using brightness increments. In principle, an arbitrarily large number of conductors that are insulated from one another can be used.

According to one embodiment, the voltage levels that are typically modulated as differential voltages may only be positive. They may also only be negative. This permits a simple embodiment. As an alternative, it is also the case that one or more voltage levels may be positive and one or more voltage levels may be negative. This permits modulation in both directions. The sign relates for example to the effect on a conductor; the sign may be opposite on the other conductor.

The embodiments furthermore relate to a transmitter for transmitting data. The transmitter comprises a bias voltage unit, which is configured to impress a respective bias voltage onto each conductor of one or two conductors of a bus line. The transmitter furthermore comprises, for each conductor, a respective modulation unit, which is designed to modulate a voltage level onto the conductor. For example, at least one modulation unit may be configured to modulate at least three different voltage levels.

For example, the method already described for transmitting data may be executed by means of a transmitter of this type. For example, one of the voltage levels may be zero so that at least two non-disappearing voltage levels are able to be modulated. The voltage levels may assume any desired value in terms of magnitude, provided this makes sense technically.

For example, one or each modulation unit may have at least two switchable driver stages. The driver stages may for example be in the form of current sources. However, they may also be of a different embodiment. In particular, the driver stages can increase and/or decrease the voltage on the respective conductor. Using at least two switchable driver stages ensures that at least two different voltage levels are able to be impressed, for example in addition to a bias voltage. This enables the execution of the method or generally the use of more than two different voltage levels. For example, more than two switchable driver stages may also be present.

For example, according to one embodiment, the driver stages or current sources of a first conductor may be designed exclusively to increase voltage and the driver stages or current sources of a second conductor may be designed exclusively to reduce voltage. This permits opposing modulation of voltage levels.

According to an alternative embodiment, one or more driver stages or current sources of a first conductor may be designed to increase voltage and one or more driver stages or current sources of the first conductor may be designed to reduce voltage. Current sources of a second conductor may be formed for example in the opposite direction to the current sources of the first conductor. As a result, both a voltage increase and a voltage decrease may take place on each conductor. For example, in this case, an opposing effect can also be achieved.

For example, the transmitter may be configured to execute a method as described herein. With respect to the method, recourse can be made to all embodiments and variants described herein. For example, the transmitter may comprise processor means and storage means, wherein the storage means contain program code, upon the execution of which the processor means execute a method.

Until now, for example the transmission of data has been considered; for example, a corresponding reception of data is considered below.

The embodiments also relate to a method for receiving data via a bus line, wherein the method comprises the following steps:
identification of a sequence of at least three different voltage levels which are modulated in a superimposed manner onto the bus line via a bias voltage, and
conversion of the sequence of voltage levels into data.

This corresponds to the method already described for transmitting data, wherein at least three different voltage levels can be identified and converted into data, provided said voltage levels can be identified and converted into data in a suitable manner. As already mentioned further above, the data transfer rate can be significantly increased as a result.

For example, the bus line may have a first conductor and a second conductor which are electrically insulated from one another. The modulation may represent for example a difference between a voltage on the first conductor and a voltage on the second conductor. The bus line may be for example a CAN bus line and/or a twisted-pair bus line. However, other implementations are also possible. In this respect, reference is made to the embodiments already given further above with respect to the method for transmitting data; the embodiments apply accordingly.

The embodiments furthermore relate to a receiver for receiving data. The receiver has a detection unit, which is configured to identify a sequence of at least three different voltage levels that are modulated in a superimposed manner onto one or two conductors of a bus line via a bias voltage. The receiver also has a data production unit, which is configured to produce data based on the sequence of voltage levels.

A data production unit of this type may produce for example data from a signal produced as already described above. This permits an increase in the transferred data rate, as already described.

For example, each detection unit may have at least two comparison units for comparing the voltage with a respective reference value. The detection unit may determine for example the deviation from the respective reference value and the result can identify the different voltage levels already mentioned. The data can be generated from this.

For example, the receiver may be configured to execute a method for receiving data, as already described. With respect to the method, recourse can be made to all embodiments and variants described herein. For example, the receiver may comprise processor means and storage means, wherein the storage means store program code, upon the execution of which the processor means execute a method.

The transmitter described herein and the receiver described herein may be provided in particular with an additional interface, wherein this interface may be used to exchange data, for example in addition to interfaces already present in known CAN bus systems. This permits a simple use of the increased data transfer capacity and the connection to other components, wherein such components typically transmit and/or receive data.

### BRIEF DESCRIPTION OF THE DRAWINGS

A person skilled in the art will find further features from the exemplary embodiments described below with reference to the appended drawing, in which:

FIG. 1: shows a transmitter according to one embodiment,

FIG. 2: shows a signal sequence,

FIG. 3: shows a receiver according to one embodiment,

FIG. 4: shows a transmitter according to another embodiment,

FIG. 5: shows another signal sequence,

FIG. 6: shows a receiver according to another embodiment,

FIG. 7: shows a transmitter according to another embodiment,

FIG. 8: shows another signal sequence,

FIG. 9: shows a receiver according to another embodiment,

FIG. 10: shows a transmitter according to another embodiment,

FIG. 11: shows another signal sequence,

FIG. 12: shows a receiver according to another embodiment,

FIG. 13: shows a bus node,

FIG. 14: shows another bus node,

FIG. 15: shows two frames,

FIG. 16: shows two further frames, and

FIG. 17: shows a signal flow.

### DETAILED DESCRIPTION

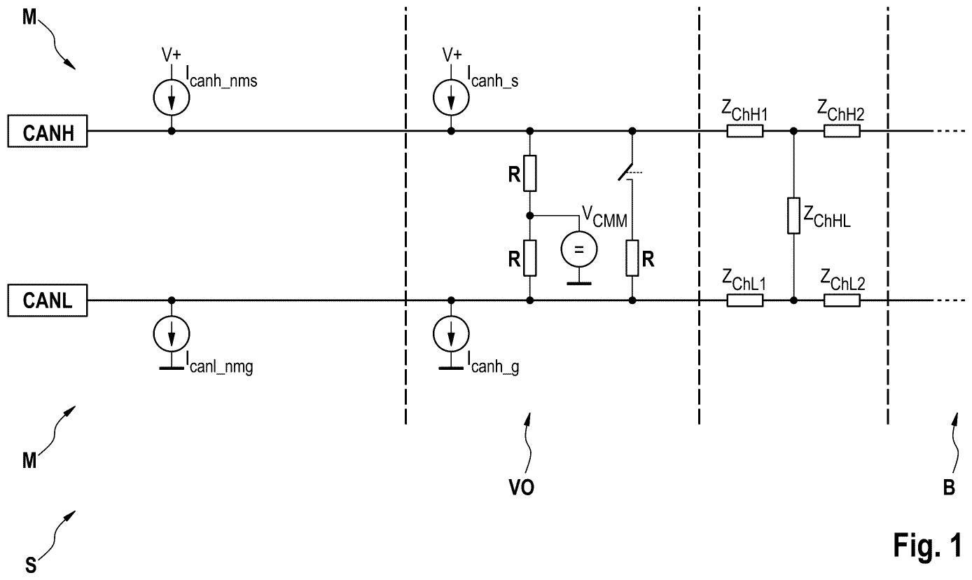

FIG. 1 shows a transmitter S according to one exemplary embodiment. The transmitter S is designed to transmit data via a bus line B. The bus line B has two conductors, wherein a first conductor is denoted by CANH and a second conductor is denoted by CANL. Data can be transferred via a voltage, that is to say a potential difference, which may be present between these two conductors CANH, CANL.

A resistor network having in the present case five resistors Z_{ChH1}, Z_{ChH2}, Z_{ChL1}, Z_{ChL2}, Z_{ChHL} and which is used for example for simulation purposes is shown on the output side of the transmitter, this resistor network not being discussed in any more detail. Said resistors may be considered constituent parts of the bus line B. This also applies to the other figures in which a resistor network of this type is shown. A resistor R with a switch arranged above is provided directly on the transmitter S, said switch being able to be used to electrically connect the two conductors CANH, CANL. Said switch may in principle also be omitted in other embodiments.

The transmitter S comprises a bias voltage unit VO which has a voltage source VCMM, which is connected to the two conductors CANH, CANL via two resistors R. The bias voltage unit VO can be used to apply a bias voltage to the bus line B, which is in a basic state, that is to say for example when no data are being transferred. In other embodiments, the bias voltage unit VO may also be omitted or be generalized as an abstract block for generating a common mode voltage on the two conductors or bus lines. A payload signal may be modulated onto the bias voltage, for which purpose the transmitter S has two modulation units M, specifically one per conductor.

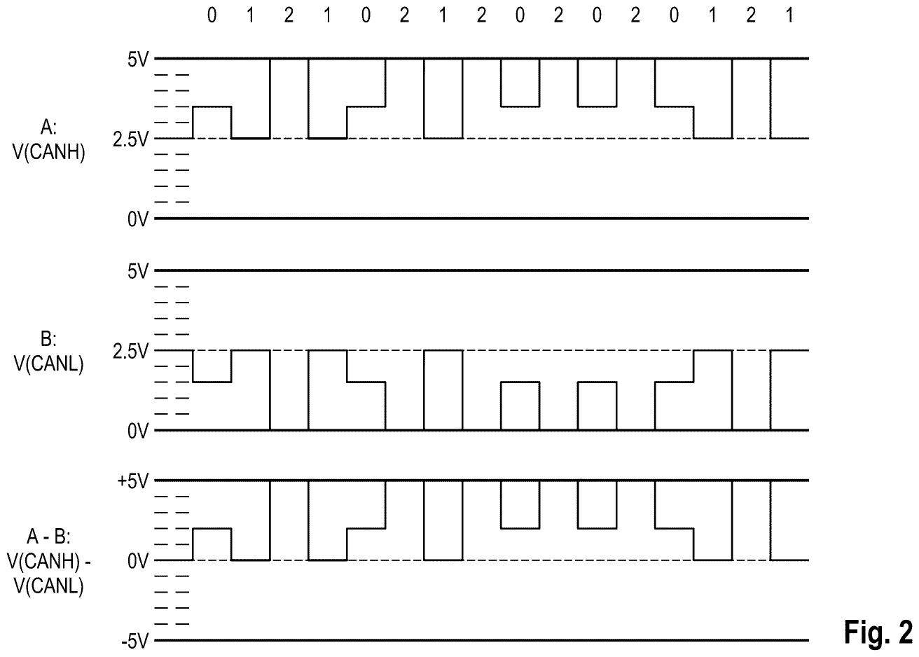

In the present case, the modulation units M each have two current sources. As shown, two current sources I_{canh_nms}, I_{canh_s} are connected to the first conductor CANH and two additional current sources _{Icanl_nmg}, I_{canh_g} are connected to the second conductor CANL. The voltage already mentioned can be varied using said current sources I, which are driver stages and together form a modulation unit M at each conductor CANH, CANL. Data can thus be transferred via the bus line B. By providing in each case two such current sources I for each of the two conductors CANH, CANL, it is possible to transfer not only zeros and ones, as is the case in conventional embodiments, but rather the data transfer rate can be increased. This is illustrated in FIG. 2.

The current sources mentioned herein are used for example to symbolize the term “modulation”. Other embodiments of power drivers can also be used.

Here, the top graph shows a time profile of the potential or the voltage V(CANH) for the first conductor CANH, the middle graph shows the time profile of the potential or the voltage V(CANL) for the second conductor CANL, and the bottom graph shows the time profile of a resulting voltage difference. As can easily be seen, in each case three different voltages can be applied to both conductors CANH, CANL. This results in three different voltage differences, which are shown at the very bottom. Each of these three different voltage differences may correspond, individually or in combination, to a different sequence of zeros and ones in binary, such that a higher data throughput compared to known embodiments is possible by means of the embodiment described herein without physically changing the bus line B. Three different states are shown as numbers at the very top of FIG. 2.

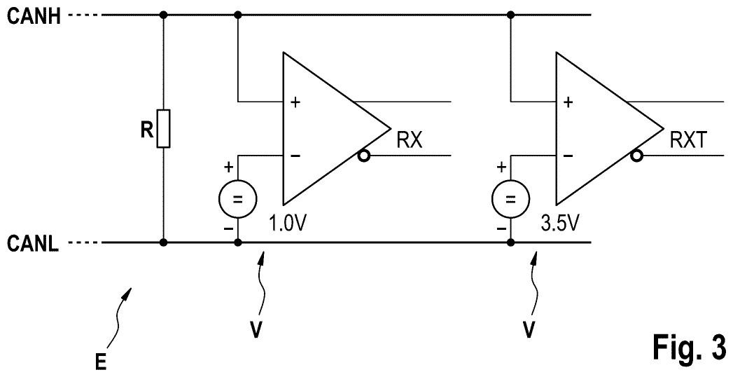

FIG. 3 shows a receiver E for receiving a signal of this type. The two conductors CANH, CANL reach here and are read out. A resistor R, by means of which the two conductors CANH, CANL are connected, is provided on the input side for this purpose. The receiver E then has two comparison units V, which in the embodiment shown are each formed of an operational amplifier, which is connected to the first conductor CANH at a positive input and to the second conductor CANL at a negative input via a respective voltage source. However, the implementation is not restricted thereto; OTAs or other circuit concepts may also be used. OTA stands for operational transconductance amplifier and refers to an amplifier that receives a voltage at the input and delivers a current at the output. The gain is then a transconductance in A/V, also referred to as Gm. The two voltage sources have different voltages, with the indicated values of 1.0 V and 3.5 V being purely exemplary in this case.

Output signals of the operational amplifiers, which are denoted by RX and RXT, each indicate whether the voltage difference between the two conductors is greater or less than the voltage of the voltage source shown in each case. Accordingly, not only two but three different voltage states can be distinguished, as a result of which the signal explained with reference to FIG. 2 and which may be produced by means of the transmitter of FIG. 1 can be read out. The output signals RX, RXT of the two operational amplifiers can be supplied to a data production device, not shown, which produces therefrom data that can be further digitally processed. Further processing of this type can be carried out for example within systems such as bus nodes, microcontrollers or control units.

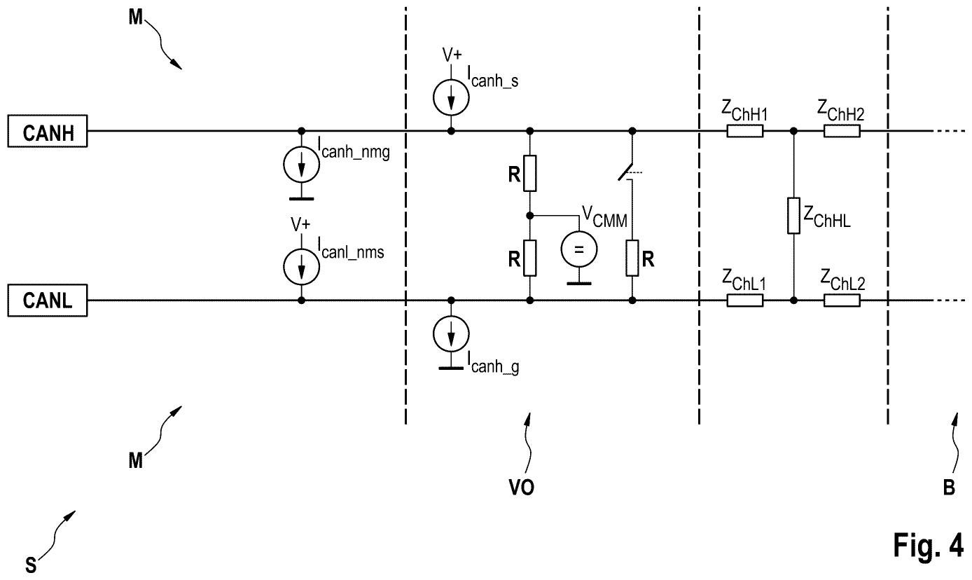

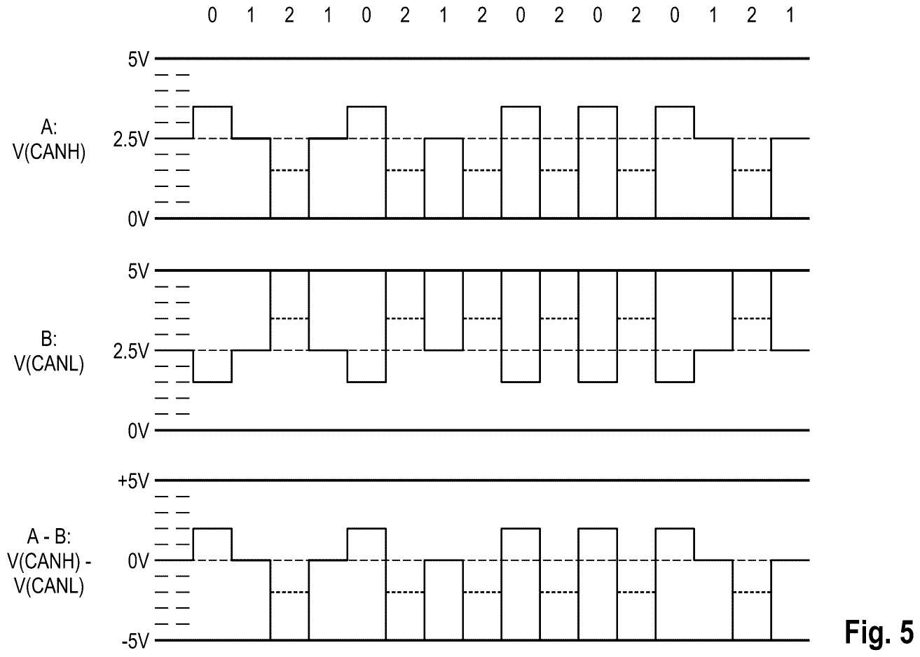

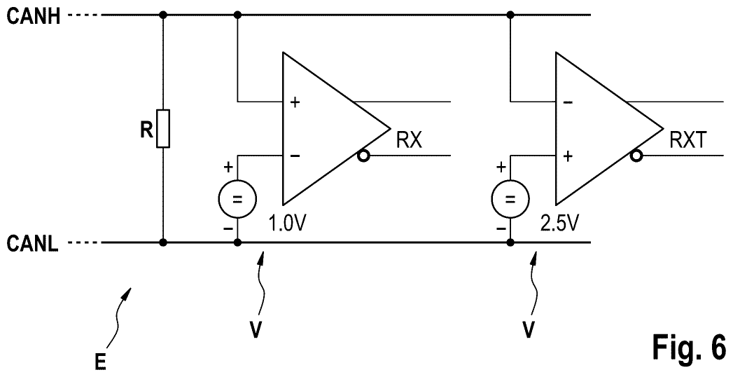

Modifications of the embodiments of FIG. 1 to 3 are described below with reference to FIG. 4 to 12, wherein in each case essentially the differences are discussed in order to explain different functionalities. In the embodiment of FIG. 4, not all current sources I for a respective conductor CANH, CANL act in the same direction, that is to say to increase the voltage or to reduce the voltage, but instead act in different directions. In the case of both conductors CANH, CANL, therefore, the voltage can be increased as well as decreased by virtue of the respective current source I being switched on. Three different states can also be realized thereby, as is illustrated in FIG. 5 based on a corresponding signal sequence. As shown, three states can also be transferred here, wherein the voltage level overall has been shifted downward in comparison to the embodiment of FIG. 2. A signal profile of this type can be received by means of the receiver E illustrated in FIG. 6, wherein only one voltage of one voltage source is different in comparison with the embodiment of FIG. 3.

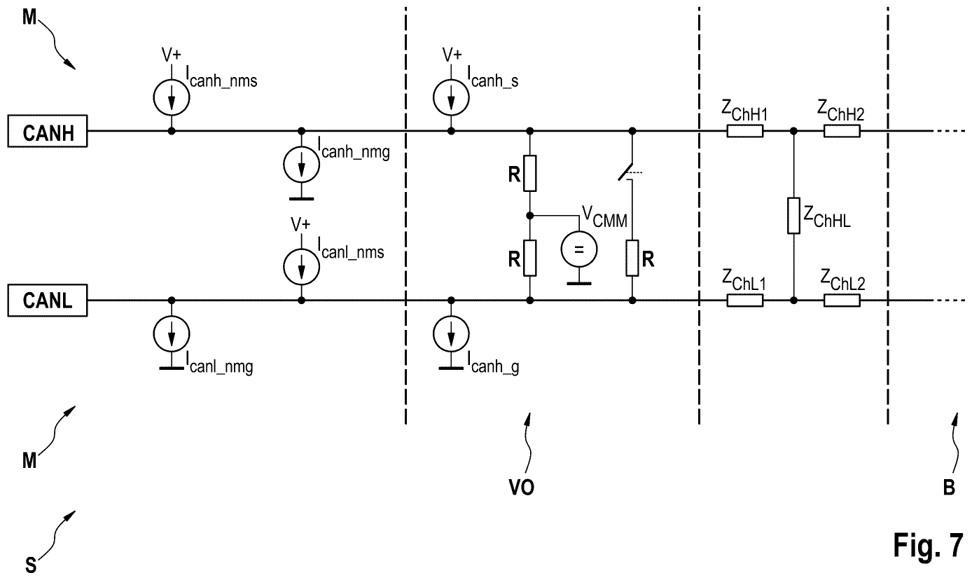

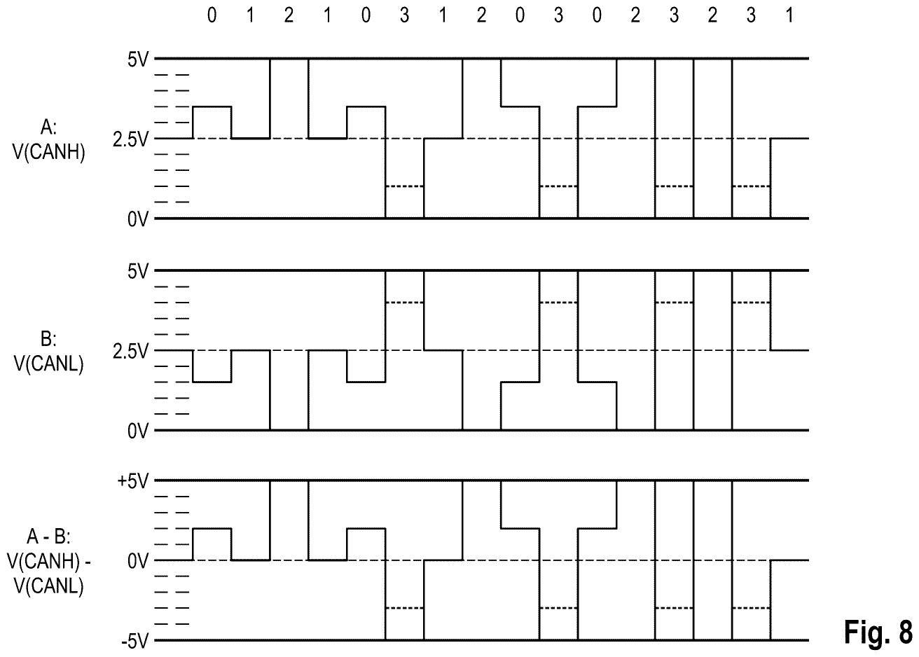

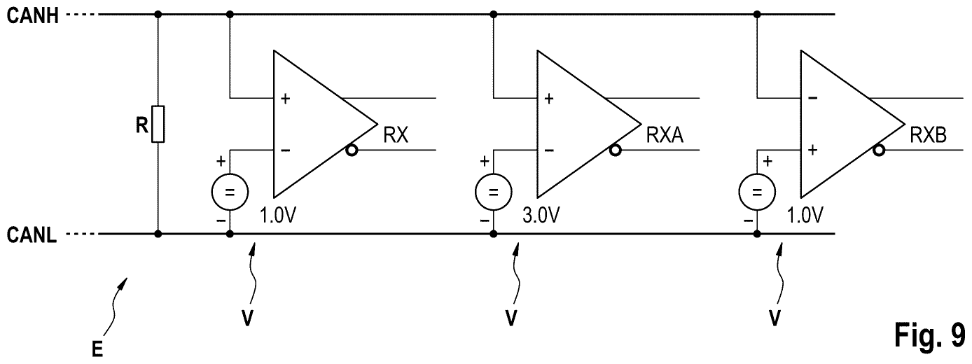

FIG. 7 shows one embodiment of a transmitter S in which two current sources I are connected to each conductor CANH, CANL, said current sources being able to increase the voltage in the case of the top conductor CANH and being able to decrease the voltage in the case of the bottom conductor CANL, wherein in each case an additional current source I acting in the opposite direction is connected. This permits even a total of four different states to be realized, which may lead to a signal transfer illustrated by way of example in FIG. 8. The associated receiver of FIG. 9, which is illustrated by way of example and can be used to receive the signal sequence, accordingly has three comparison units V.

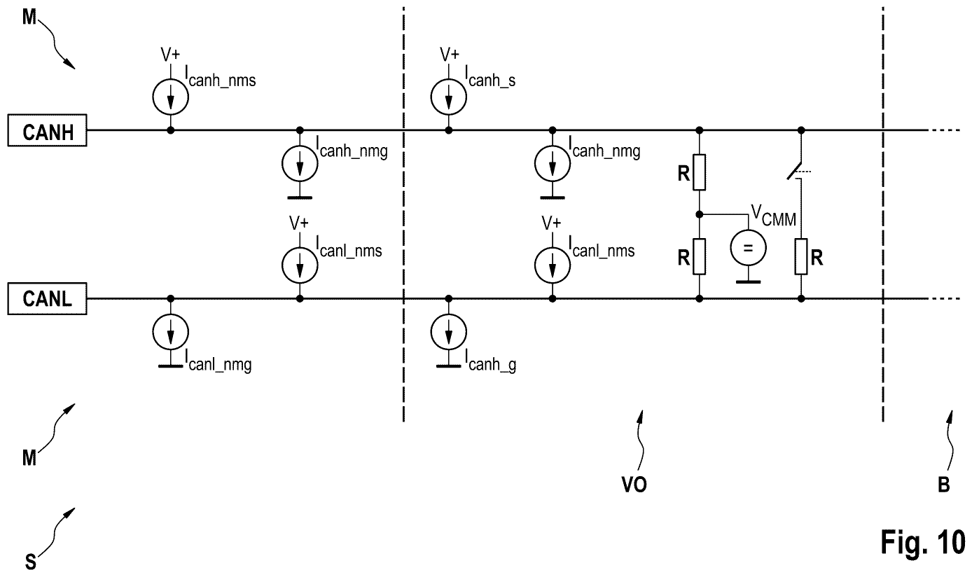

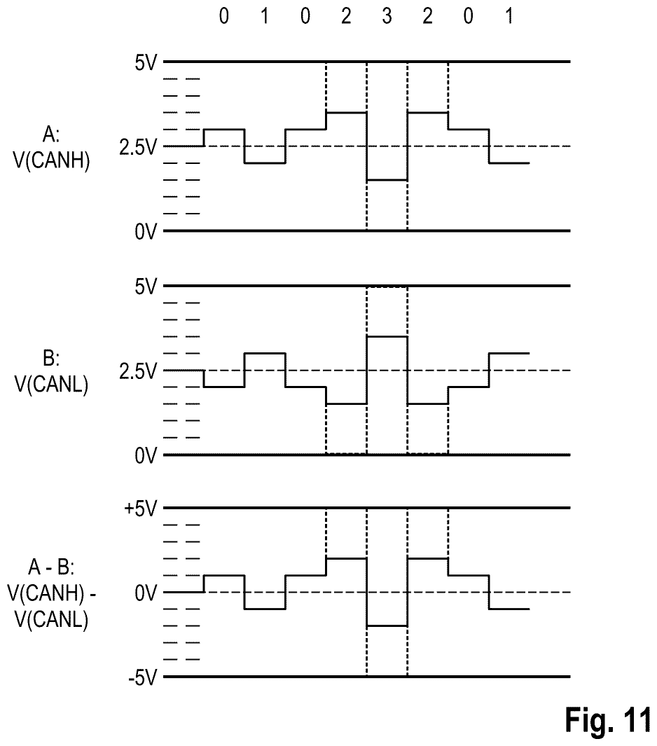

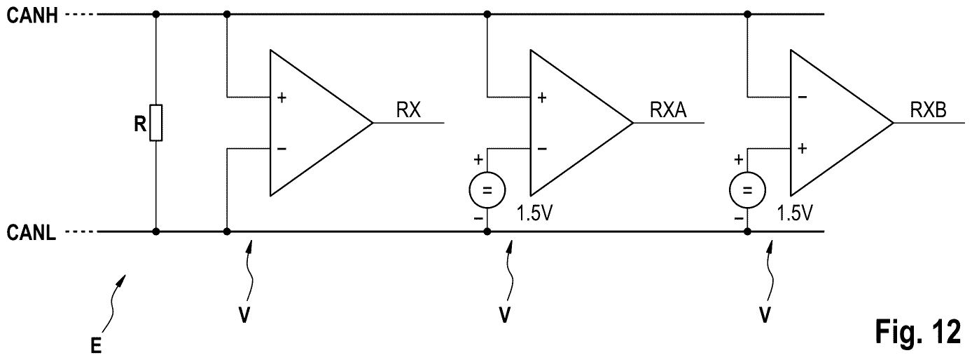

FIG. 10 shows another alternative embodiment, wherein, for each of the conductors CANH, CANL, in each case two current sources I able to increase the voltage and also two current sources I able to decrease the voltage are connected. The signal sequence illustrated by way of example in FIG. 11 and with a total of four different states can thus be produced, said signal sequence being able to be detected using the receiver E illustrated in FIG. 12. In this case, a voltage source is omitted in one of the operational amplifiers so that the position above or below the bias voltage can be identified immediately. Two additional operational amplifiers or other electronic or electrical components with a corresponding functionality accordingly suffice to detect the total of four possible different levels.

It should be understood that in principle more than four different states (for example five, six, seven, eight or more states) can also be used.

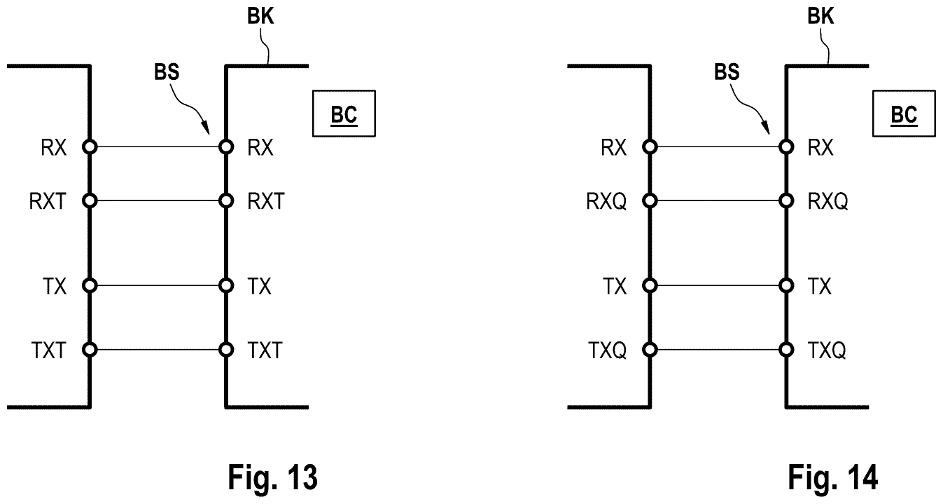

FIG. 13 shows a bus node BK which has a bus controller BC. The bus controller BC may take on general control tasks. For example, it represents the possibility of implementing a data flow between controller and transceiver. Other implementations are also possible.

The bus node BK also has a bus interface BS to a further unit, illustrated on the left-hand side and not described in any more detail, wherein the bus interface BS not only has a reception line RX and a transmission line TX, as in known embodiments, but additionally also has an additional reception line RXT and an additional transmission line TXT. The bus interface BS is thus designed for ternary communication, that is to say a higher data transfer can be achieved in both directions compared to known embodiments, and specifically through the use of three different voltage levels for data transfer. The higher data transfer power can be used by the bus interface BS illustrated here since a connection to other components with a higher data transfer rate is also possible.

FIG. 14 shows a corresponding embodiment for quaternary communication, that is to say for the use of four different voltage levels. In this case, additional lines RXQ, TXQ, which are designed for an even higher data throughput, are present.

For example, a possible interface for ternary modulation on the PHY (for example using signal lines RXT/TXT) is shown in FIG. 13. A possible interface for quaternary modulation on the PHY (for example using signal lines RXQ/TXQ) is shown for example in FIG. 14. An interface itself can be used for both modulation variants without being changed.

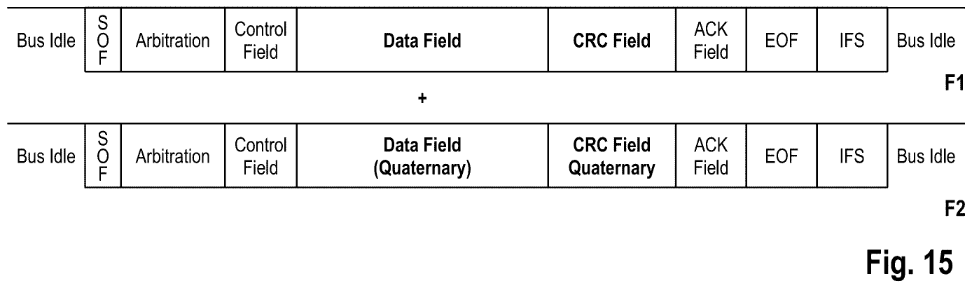

FIG. 15 shows two frames, wherein a first frame F1 is illustrated at the top and a second frame F2 is illustrated at the bottom.

Both frames F initially begin on the far left-hand side after “Bus Idle”, that is to say an idle state on the bus line B in which no data are transferred. The respective frame F then begins with a field SOF, which marks the start of the respective frame. There is then arbitration, in which the additional connection is established and controlled. This is then followed by a control field, which can be used to handle general control tasks. Both frames F then have a data field, where these are transferred simultaneously, since in the present case quaternary modulation is used, that is to say the use of four different voltage levels. This is only exemplary in this case; for example, ternary or a different modulation could also be used. The data transfer rate is accordingly higher than would be possible when using binary communication and accordingly multiple frames, in the present case two frames F1, F2, can be transferred simultaneously. There then follows a checksum field “CRC field”, in which checksums are transferred to ensure proper communication. Finally, both frames F have a respective confirmation field “ACK field”, an end field “EOF”, and an additional field “IFS”. After the two frames F have been transferred, there is an idle state again on the bus.

The embodiment described here can be used to simultaneously transfer two frames F1, F2, whereas only one frame can be transferred simultaneously in known embodiments. It is thus possible to achieve a considerably higher data throughput by means of the embodiment described herein. This is due to the use of more than two different voltage levels.

The concept of the first frame F1 and the second frame F2 may be expanded as desired, that is to say more frames can also be used and transmitted simultaneously. Re-use is then also possible, that is to say in principle first frames F1 can be transmitted simultaneously with second frames F2.

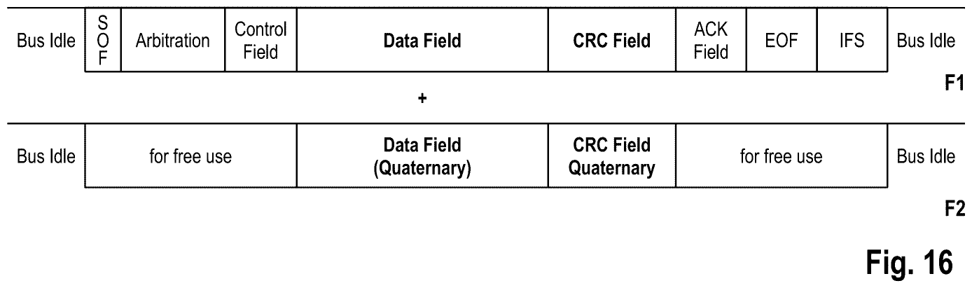

FIG. 16 shows an alternative embodiment in this respect, wherein the fields upstream and downstream of the data field and the checksum field are formed differently in the second frame F2. These fields are for free use, that is to say they may also be populated with payload data. Said payload data may be transferred simultaneously with the fields illustrated in the first frame F1, which take on control tasks on the bus or in the communication. This can achieve an even more increased data transfer.

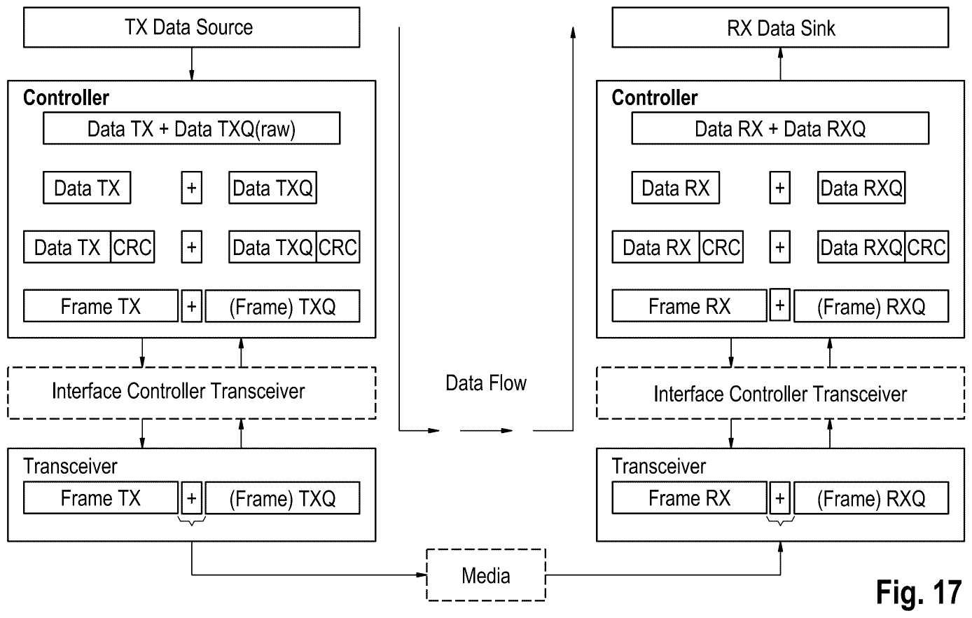

FIG. 17 shows a fundamental data flow from a source “TX Data Source” to a sink “RX Data Sink”. The data are first supplied to a controller, which divides the data into data TX and data TXQ, with the latter data being data that can be transferred in addition to the data that can already be transferred in embodiments from the prior art on account of quaternary communication. Respective checksum fields CRC are produced for the data. These data are packed together with their checksum fields in frames TX and TXQ, which are then processed further and for example are transmitted. For this purpose, they are supplied to an interface controller/transceiver, which forwards them to a transceiver, which may also be referred to as a transmitter. As described with reference to FIG. 15 and FIG. 16, the frames are then transmitted together and thus arrive on the bus line B, which is generalized in FIG. 17 to a medium “Media”. They are then received by an additional transceiver and again supplied to a controller via an interface controller/transceiver. There, the corresponding frames are extracted, the checksums are verified and, in the event of successful transfer being identified, the extracted data are supplied to the data sink RX Data Sink. This results overall in a flow of data denoted by Data Flow.

A significantly higher data transfer rate can be achieved overall by way of the embodiment described herein since more than just two voltage levels are used, wherein the additional outlay in terms of apparatus is minimal.

Mentioned steps of the method can be executed in the specified order. However, they may also be executed in another order, provided this makes technical sense. The method may, in one of its embodiments, for example with a particular set of steps, be executed in such a way that no additional steps are executed. However, in principle, additional steps may also be executed, even those that are not mentioned.

It should be pointed out that features may be described in combination in the claims and in the description, for example to facilitate understanding, even though said features may also be used separately from one another. A person skilled in the art knows that such features may also be combined independently of one another with other features or combinations of features.

Back references in subclaims may denote combinations of the respective features, but do not exclude other combinations of features.

1. A method for transmitting data via a bus line comprising:
receiving the data to be transmitted,
inserting the data into respective data fields of at least first frames and second frames, and
simultaneously transmitting in each case one first frame with one second frame.

2. The method as claimed in claim 1, wherein a sequence of at least three different voltage levels is used in the transmission of the data fields.

3. The method as claimed in claim 1, wherein each frame has a checksum field into which calculated checksums of the data obtained in the respective data field are inserted.

4. The method as claimed in claim 3, wherein the total length of the checksum fields of a first frame and a simultaneously transmitted second frame is shorter than twice the length of a checksum field of a frame in the case of the data field with the same length.

5. The method as claimed in claim 1, wherein the data fields and/or checksum fields of the frames are of the same length.

6. The method as claimed in claim 1, wherein the first frames are CAN frames for CAN bus systems with only two different voltage levels or are backward-compatible with such CAN frames.

7. The method as claimed in claim 1, wherein each frame has header fields upstream of the data field and/or checksum field; and/or wherein each frame has trailer fields downstream of the data field-fata and/or checksum field.

8. The method as claimed in claim 1, wherein bits of the data field of a first frame and of the data field of a simultaneously transmitted second frame are transmitted simultaneously by the at least three different voltage levels.

9. The method as claimed in claim 1, wherein the data field and/or checksum field of two simultaneously transmitted frames are transmitted simultaneously.

10. The method as claimed in claim 1, wherein arbitration data and/or control data are transmitted in addition to the data field and/or checksum field only in the first frame.

11. The method as claimed in 1, wherein arbitration data and/or control data are transmitted in addition to the data field and/or checksum field both in the first frame and in the second frame.

12. The method as claimed in claim 1, wherein the data are also inserted into respective data fields of a third frame, or a third frame and one or more additional frames, and wherein in each case one first frame is transmitted simultaneously with a second frame and a third frame, or in each case one first frame is transmitted simultaneously with a second frame a third frame and one or more additional frames.

13. The method as claimed in claim 1, wherein a sequence of four or more different voltage levels is used in the transmission of the data fields and/or in the transmission of the checksum fields.

14. The method as claimed in claim 1, wherein the bus line is a CAN bus line, and/or wherein the bus line is a twisted-pair bus line.

15. A bus node of a bus system; comprising:
a bus interface
wherein the bus interface is designed to transmit data using at least two, three or at least four different voltage levels, and
configured to execute the instructions for:
receiving the data to be transmitted,
inserting the data into respective data fields of at least first frames and second frames, and
simultaneously transmitting in each case one first frame with one second frame.
